(19) United States
(12) Patent Application Publication
(10) Pub. No.: US 2025/0085214 A1
(43) Pub. Date: Mar. 13, 2025

(54) METHOD FOR OPERANDO CHARACTERIZATION OF CHEMICAL SPECIES WITHIN A BATTERY USING INFRARED EVANESCENT WAVE SPECTROSCOPY

(71) Applicants: CENTRE NATIONAL DE LA RECHERCHE SCIENTIFIQUE, Paris (FR); COLLÈGE DE FRANCE, Paris (FR); SORBONNE UNIVERSITÉ, Paris (FR); UNIVERSITÉ DE RENNES 1, Rennes (FR); ECOLE NATIONALE SUPERIEURE DE CHIMIE DE RENNES, Rennes (FR); INSTITUT NATIONAL DES SCIENCES APPLIQUEES DE RENNES, Rennes (FR)

(72) Inventors: Jean-Marie TARASCON, Paris (FR); Charlotte GERVILLIE, Paris (FR); Catherine BOUSSARD, Betton (FR); Xiang-Hua ZHANG, Cesson-Sévigné (FR); Jean-Luc ADAM, Rennes (FR)

(21) Appl. No.: 18/292,778

(22) PCT Filed: Jul. 29, 2022
(86) PCT No.: PCT/EP2022/071395

§ 371 Date: Jan. 26, 2024

(30) Foreign Application Priority Data
Jul. 30, 2021 (EP) 21306068.4

(51) Int. Cl. G01N 21/25; G01N 21/31; G01N 21/35; G01N 21/3563; H01M 10/48

(52) U.S. Cl. CPC G01N 21/255; G01N 21/3563; H01M 10/48; G01N 2021/3196; G01N 2021/3595

(57) ABSTRACT

Method for operando characterization of the chemical composition of a battery cell, comprising the following steps: inserting an optical fiber made of chalcogenide glass through the battery cell, cycling the battery, while cycling the battery, generating an optical signal and transmitting it through the optical fiber, detecting, using an infrared spectrometer, the transmitted optical signal at an output extremity of the optical fiber, recording the detected optical signal over time, locating, using fiber evanescent wave spectroscopy, signature wavelengths for which the optical signal intensity is above a predetermined threshold within the spectrum, associating the located signature wavelengths to at least one predetermined chemical species.

The invention relates to the field of batteries, and more particularly the field of characterizing the chemical species involved in the formation of the solid electrolyte interface layer (SEI) for batteries, that are forming upon battery cycling and the observation of the electrolyte degradation which include but not limit to Lithium ion (Li-ion) and Sodium-ion (Na-ion) batteries.

With batteries being increasingly used in both the transport and power sectors, there exists a need to increase their reliability and performance.

It is well-known in the field of batteries that the formation of the SEI layer, a passivating film that results from the self-limited partial catalytic decomposition of the electrolyte at the electrode surfaces for potentials beyond its range of thermodynamic stability, is one of the major factors influencing the performance of the battery cell over time. Indeed, even though the formation of the SEI Layer is essential for the battery cell to function, if it occurs in excess, it may lead to undesirable lithium ions consumption, significant increases in impedance, and the reduction of the active electrode area, leading to a decrease of the performance of the battery cell over time. As such, the formation of SEI and its stability, which mainly controls the cell lifetime is a critical and expensive step in cell manufacturing, rendering the protocols as trade secrets among the manufacturers. Similarly, based on the dynamic nature of the SEI, knowing the chemical evolution of the electrolyte when ageing or upon cycling is important in order to have a better understanding of the degradation phenomena

In the past, sensing activities within the field of batteries have mainly relied on the use of sensors placed outside, rather than inside battery cells. Knowledge of the internal chemical and/or physical parameters is therefore limited. More recently, the development of implantable optical sensors that can measure, via non-disruptive approaches, multiple parameters such as temperature, pressure, strain, electrolyte composition, and heat flow with high sensitivity at various locations within the cells has been developed. To that end, together with the relative signal stability of the optical signal and their suitability for wavelength multiplexing, physicists back in 2013 began using SMF-FBG (Single Mode Fiber-Fiber Bragg Grating) sensors.

However, these techniques do not allow knowing the nature and the formulae of the chemical species, which are necessary to fully understand the cascade-reactions mechanism leading to the formation of the SEI. The invention aims to overcome this limitation by allowing the identification of the electrolyte decomposition pathway and the chemical composition parasitic chemical species, such as alkyl carbonates and polyethylene glycol, forming the SEI.

To that end, the invention relates to a method for operando characterization of the chemical composition of a battery cell, comprising the following steps:
inserting an optical fiber made of chalcogenide glass through the battery cell,
generating an optical signal and transmitting it through the optical fiber,
detecting, using an infrared spectrometer, the transmitted optical signal at an output extremity of the optical fiber,
recording the detected optical signal over time,
locating signature wavelengths for which the optical signal intensity is above a predetermined threshold,
associating said located signature wavelengths to at least one predetermined chemical species.

The invention is based on the realization that the organic electrolyte and its decomposition products interact by absorption with infrared radiation within the 3 to 15 microns wavelength region. The invention aims to take advantage of this by considering transmitting an infrared signal within the electrolyte and to identify chemical species that appear while cycling the battery and affect said infrared signal using evanescent wave spectrometry. However, traditional silica (SiO₂) optical fibers, commonly used in telecommunications, transmit solely in the 0.8 to 2 microns wavelengths, hence rendering infrared detection impossible.

Preferably, the optical signal has a wavelength comprised in the mid-infrared, and preferably comprised between 3 to 13 microns.

An aspect of the invention is therefore to use chalcogenide (Sulfides, Selenides, Tellurides) glasses that can transmit over the 3 to 13 microns wavelengths: by inserting a chalcogenide optical fiber through a battery cell and transmitting an optical signal through said fiber, the evanescent wave from the optical fiber will interact with the electrolyte of the battery cell and especially the organic solvents decomposition products that will appear during cycling of the battery, or with the electrode of the battery cell should the optical fiber be placed within the electrode.

This in turn will affect the transmitted optical signal at an output extremity of the optical fiber. Thus, by recording said signal, using evanescent wave spectroscopy, it is possible to establish a spectrum of the recorded optical signal, locate signature peaks of the spectrum and associating said located signature peaks to predetermined chemical species, it is possible to identify the degradation and formation of chemical species during battery cycling and/or ageing, but also at which point in this cycling they appear. In further applications it is also possibly to assess the molar quantity of these chemical species.

The invention therefore allows to record in real-time, in operando, the appearance of chemical species and even quantify them. It is particularly advantageous to apply the method over time.

This opens the way to better understanding the degradation mechanism and instabilities of electrolytes which are linked to the apparition of certain chemical species, and therefore provide guidance to cure such parasitic reactions to enhance battery lifetime. In particular, the formation of the SEI may be closely monitored using the invention. In addition, owing to this real-time knowledge of the chemical composition of the electrolyte, one may study the influence of different parameters such as temperature, current, voltage, etc. on the battery cycling. Finally, the method according to the invention can be adapted to any kind of battery cell, rendering it particularly convenient.

Moreover, it is possible to follow ion intercalation within the materials constituting the structure of the cell by performing the method over time, in operando.

According to a particular embodiment of the invention, the method further comprises a step of cycling the battery, wherein the steps of generating an optical signal and transmitting it through the optical fiber, detecting, the transmitted optical signal at an output extremity of the optical fiber, and recording the detected optical signal over time are performed while cycling the battery. This in particular allows to identify the degradation and formation of chemical species during battery cycling

Preferably, to simplify the location of the signature wavelengths and their association to predetermined chemical species, after recording the detected optical signal over time, the method comprises a step of establishing a spectrum of said recorded optical signal.

In order to obtain not only the chemical composition of the battery, but also quantify the thus-characterized chemical species, the method further comprises a step of associating the recorded optical signal intensities of said signature wavelength to a molar quantity of the at least one predetermined chemical species.

To facilitate the characterization of the chemical species, the step of associating signature peaks to at least one predetermined chemical species includes a step of comparing the located signatures wavelengths to a spectra database associating particular infrared wavelengths to predetermined chemical species.

Preferably, the spectra database also includes a calibration curve associating a molar quantity of the at least one predetermined chemical species to the intensity of the optical signal for a particular wavelength.

Accord to particular embodiment of the invention, the method comprises a prior step of establishing the spectra database. Another possibility is to use already-established tables that provide absorption frequencies, usually expressed in wave numbers, for common types of molecular bonds and functional groups.

Accord to particular embodiment of the invention, the step of establishing the spectra database comprises the following sub-steps:
inserting an optical fiber made of chalcogenide glass in a solution of a predetermined chemical species,
detecting, using the infrared spectrometer, the transmitted optical signal at an output extremity of the optical fiber,
recording the detected optical signal,
locating a wavelength or a set of wavelength for which the recorded optical signal has an intensity above a predetermined threshold,
entering within the spectra database the association of said wavelength or a set of wavelength to said predetermined chemical species.

In order to be able to quantify the quantity of chemical species within the battery, the molar quantity of the predetermined chemical species within the solution is recorded and the association of the intensity of the recorded optical signal of the wavelength or set of wavelengths and the molar quantity of the predetermined chemical species is entered in the database.

According to a particular embodiment of the invention, the optical fiber is embedded in an electrode of the battery cell. This allows to characterize the chemical species of the SEI and the phases that will form the SEI.

According to a particular embodiment of the invention, the optical fiber is inserted through the electrolyte of the battery cell. This allows to characterize the chemical species within the electrolyte of the battery.

According to a particular embodiment of the invention, a first fiber is embedded in an electrode of the battery cell and a second optical fiber is inserted through the electrolyte of the battery cell. In that way, both the evolution of the SEI and the composition of the electrolyte may be monitored in parallel.

Preferably, the optical fiber is made from a material comprising essentially Te₂As₃Se₅ glass. This kind of chalcogenide glass is particularly suited to the invention as it easily is transparent to infrared signals the wavelengths or which are absorbed by the typical chemical species of batteries. An optical fiber according to FR2958403, which is hereby included by reference, can be particularly used.

Preferably, the diameter of the optical fiber is comprised between 100 and 400 μm. Indeed, should its diameter be above 400 μm, the fiber becomes rigid and inconvenient to connect to distant apparatuses. On the other hand, should its diameter be under 100 μm, it becomes to fragile or difficult to handle.

Preferably, in order to be able to transmit infrared signals the wavelengths or which are absorbed by the typical chemical species of batteries, the chalcogenide glass of the optical fiber is transparent to an electromagnetic radiation the wavenumber of which is comprised between 2 and 12 μm.

According to a particular embodiment, the optical fiber is covered with a coating made of the same material as an electrode of the battery cell, said coating preferably having a thickness comprised between 0 and 10 μm.

Owing to the coating made of a material similar to the one of the electrode, during operation of the battery cell, a SEI deposit similar to the one that will form on the electrode will form on the outer surface of the fiber. Hence, the evanescent wave will interact with said SEI deposit and will enable the identification of the species contained within the SEI of the electrode. This allows for a very precise detection of the species contained within the SEI as the SEI is directly in contact with the fiber, and hence will be in direct contact with the evanescent wave generated by the optical signal.

According to a particular embodiment, in order to increase the outer surface of the optical fiber, its cross-section is star-shaped or disk-shaped including a local section that is V-shaped.

The invention also concerns a characterization device for identifying the chemical species within a battery cell, comprising:
an optical fiber made of chalcogenide glass inserted through the battery cell,
an electrical power source for charging and discharging the battery,
an infrared optical signal generator generating, while cycling the battery, an optical signal through the optical fiber,
a detector detecting the optical signal transmitted through the optical fiber at an output extremity of the optical fiber,
a memory for recording the detected optical signal,
a processor locating signature wavelengths for which the optical signal intensity is above a predetermined threshold within the spectrum and associating said located signature wavelengths to at least one predetermined chemical species.

According to a particular embodiment of the invention, the optical signal generator and detector are comprised within a spectrometer which is a Fourier transformed infrared spectrometer, preferably including a Mercury-cadmium-telluride detector with for example a spectral range comprised between 12000 cm⁻¹ and 600 cm⁻¹. This kind of apparatus is particularly well-suited for putting the invention into practice as it is convenient to use and provides a suitable precision.

### BRIEF DESCRIPTION OF THE FIGURES

The invention will be better understood in view of the following description, referring to the annexed Figures in which:

FIG. 1 is a schematic figure of a characterization device according to a first particular embodiment of the invention;

FIG. 2 is a schematic cut-off figure of the optical fiber of the characterization device of FIG. 1;

FIG. 3 is a first graph illustrating a spectrum obtained using the characterization device and method according to the invention;

FIG. 4 is a second graph illustrating a spectrum obtained using the characterization device and method according to the invention and a graph illustrating the cycling of the battery of FIG. 1.

FIG. 5 is a schematic cut-off figure of the optical fiber of the characterization device within the electrode of a battery according to a second particular embodiment of the invention,

FIG. 6 is a schematic cut-off figure of the optical fiber of the characterization device within the electrode of a battery according to a third particular embodiment of the invention,

FIG. 7 is schematic cut-off figure of optical fibers of the characterization device according to variants.

### DETAILED DESCRIPTION

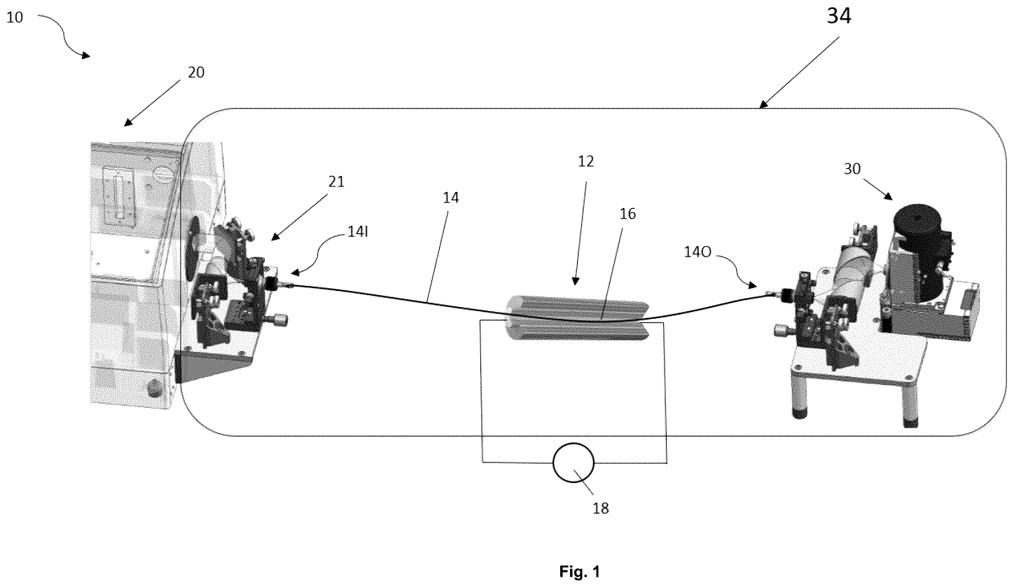

A characterization device 10 for identifying the chemical species within a battery cell 12 is shown on FIG. 1.

Characterization device 10 comprises an optical fiber 14 made of chalcogenide glass inserted through the battery cell 12. Battery cell is preferably a Na-ion or Li-ion battery, and can have different formats such as a 18650, pouch, CR2032 or swagelock. On FIG. 1, the battery cell is a 18650 cell. Naturally, it should be noted that these are merely examples of types and formats of battery cells and the invention may be used for any type of battery cell.

As can be seen on FIG. 1, the optical fiber 14 is inserted through (embedded into) an electrode 16 of the battery cell 12. The electrode 16 can be either the positive, the negative electrode. As an alternative, the optical fiber 14 passes through the jelly roll of the battery cell 12 in its central space.

This allows to characterize the chemicals species within the electrode 16 material (either negative or positive). However, according to another embodiment, the optical fiber 14 may be inserted through the electrolyte of the battery cell 12 in order to characterize the chemicals species within the electrolyte. In that case, fiber 14 is integrated in the electrolyte between the separators (not shown on the Figures) of battery cell 12.

For example, the integration of the optical fiber into a 18650 cell 12 is presented in FIG. 1. The 18650-instrumented cell is drilled with two holes of 0.8 mm on the center of the negative and positive sides of the cell 12 to allow the fiber 14 to pass through the central void of the jellyroll. The drilled cell 12 is dried under vacuum overnight at 80° C. and introduce in argon-filled glove box. Using a needle (for example of a diameter of 0.45 mm) as a guide, the optical fiber 14 with a length of about 60 centimeters is passed through the cell 12. Once the fiber 14 is placed with approximately the same length of fiber going out from each part of the cell, the hole on the positive electrode side is closed with epoxy and cured for 24 hours. Then, about 5.3 ml of electrolyte is injected from the hole on the negative side. Finally, the second hole is also sealed with epoxy and cured for 24 hours.

According to this first embodiment of the invention, optical fiber 14 is placed within, and thus surrounded, by the electrolyte of cell 12.

Preferably, optical fiber 14 is made from a material comprising essentially Te₂As₃Se₅ glass. It should be noted that a material “comprising essentially” Te₂As₃Se₅ glass means that comprises at least 99% Te₂As₃Se₅ glass. For instance, impurities such as hydrogen can be occasionally found in the glass but do not factor for more than 1% of the optical fiber. This kind of chalcogenide glass is particularly suited to the invention as it easily is transparent to infrared signals the wavelengths or which are absorbed by the typical chemical species of batteries. In addition the glass transition of the Te₂As₃Se₅ fiber is 137° C., which allows the integration in battery cells 12.

The diameter of the optical fiber 14 is preferably comprised between 100 and 400 μm. Indeed, should its diameter be above 400 μm, the fiber becomes rigid and inconvenient to connect to distant apparatuses. The diameter of the optical fiber 14 might be constant or the fiber 14 may be locally tapered to improve detection, as exemplified above. On the other hand, should its diameter be under 100 μm, it becomes to fragile or difficult to handle.

Preferably, in order to be able to transmit infrared signals the wavelengths or which are absorbed by the typical chemical species of batteries, the chalcogenide glass of optical fiber 14 is transparent to an electromagnetic radiation the wavenumber of which is comprised between 2 and 12 μm. In other words, spectrometer 20 emits in the mid-range infrared.

Characterization device 10 comprises an electrical power source 18 for charging and discharging the battery 12 in a sequential manner, also known as cycling the battery 12. Such an electrical power source 12 is known in itself and will not be described further.

Characterization device 10 also comprises an infrared optical signal generator generating, while cycling the battery, an optical signal through the optical fiber 14. The optical signal generator is the present case part of a spectrometer 20. A focusing accessory 21 may be added to focus the infrared beam emitted by the spectrometer 20 as can be shown on FIG. 1.

The infrared optical signal is sent to optical fiber 14 at an input extremity 14I of the optical fiber 14, shown on the left of FIG. 1.

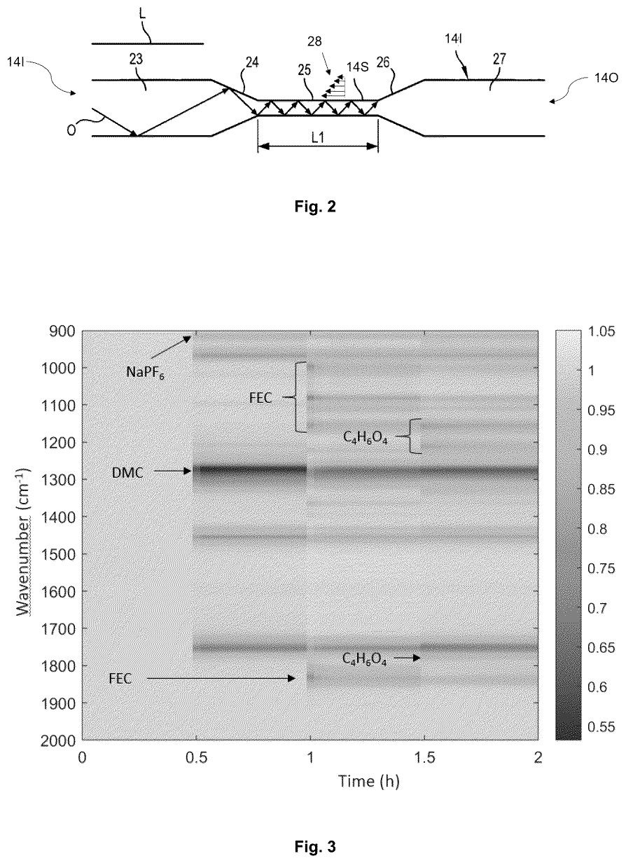

More particularly, as can be seen on FIG. 2, fiber 14 extends in a general longitudinal direction L between input end 14I and output end 14O.

Fiber 14 comprises, from the input end 14I to the second end 14O, a first fiber section 23 for guiding infrared waves, this first section 23 being connected on its side remote from the input end 14I to a first point connection 24 of a second, detection section 25, said second section 25 being connected by a second point 26 remote from the first connection point 24 to a third fiber section 27 for guiding infrared waves.

The second sensing section 25 of the fiber 2 has a transverse width in at least one dimension, a diameter or cross-section, which is less than the transverse width, or diameter or cross-section of the first section 23, and which is less than the transverse width, diameter or cross-section of the third section 27. In other words, the second sensing section 25 is tapered. However, it is also possible to use a fiber 14 that is homogenous diameter or cross-section along its entire length.

The second sensing section 25 of the fiber 2 extends over a non-zero length L1 of the fiber 14 between the first and second connection points 24, 26 and between the first section 23 and the third section 27.

For example, the fiber 14 has an average diameter of about 400 μm in the first section 23 and in the third section 27, while the fiber 14 has an average diameter of about 100 μm in the second detection section 25 for a length L1 of the second detection section of about 10 cm. The first section 23 is longer than the length of the second detection section 25. The third section 27 has a length greater than the length L1 of the second detection section 25.

The first connection point 24 is for example formed by a cross-sectional area tapering from the first section 23 to the second detection section 25, being for example truncated conical as shown in FIG. 2. The second connection point 26 has for example a cross-section widening from the second detection section 25 to the third section 27, being for example truncated conical in shape as shown in FIG. 2. Between the first and second connection points 24, 26, the second detection section 25 has for example a constant cross-sectional width and/or a constant cross-sectional diameter and/or a constant cross-section.

The second detection section 25 is intended to come into contact with an external medium in order to detect the disturbances brought by this external medium to the propagation of the infrared waves in the fiber 14. In this particular embodiment, second detection section 25 being tapered, it makes the optical fiber 14 more sensitive to those disturbances it allows more reflections of the infrared waves within second section 25.

FIG. 2 shows the path of an optical signal O, here an infrared wave, sent from the input end 14I into the section 23 by thick arrows inside the fiber 14. Due to the narrowing of the cross-section of the fiber 14. In the second detection section 25, there are more reflections of the wave in this second section 25 against the outer surface 14S of the fiber 14.

When an external medium is brought into contact with the second sensing section 25, the propagation of the infrared wave O in this second section 25 is disturbed, due to the fact that a portion of the infrared wave O passes from the second section 25 to the external medium. Therefore, the contact of the second detection section 25 with an external medium will have an influence on the infrared wave O which will be transmitted from first section 23 to third section 27.

To be more precise, infrared wave O propagates through the fiber 14 by a series of total internal reflections within second section 25. The interference between the incident and reflected optical signal waves results in the generation of an evanescent wave field 28 inside the sample, which is a function of its refractive index and which amplitude decreases exponentially from the fiber core. The evanescent wave field 28 will be partially absorbed at each reflection leading to a reduction of the corresponding wavelength in the transmission spectra.

NLdθ The number of reflections ( ) is a function of the fiber length ( ) its diameter ( ) and the angle of incidence of the light from normal ( ):

$$NL d θ$$

$$N = L \frac{tan ( 90 - θ )}{d}$$

Here, the external medium being the electrode 16, or the electrolyte in other variants, of battery cell 12, the chemical composition of the electrode 16, notably bonds of the molecules composing the chemical components, will have an influence of the infrared wave O transmitted from input end 14I to output end 14O.

The working principle behind the invention is to take advantage of this fact and use fiber evanescent wave spectroscopy.

Hence, characterization device 10 comprises a detector 30 detecting the optical signal transmitted through the optical fiber 14 at an output extremity of the optical fiber 14O as the optical fiber 14 is used in a transmission mode.

However, in another, non-illustrated variant, detector 30 could be placed at the input 14I extremity of the optical fiber in case it is used in a reflection mode. In that case, a mirror is placed at the output extremity 14O of the fiber.

It should also be noted that even though detector 30 is a separate device from spectrometer 20 on FIG. 1, this is only an exemplary embodiment as detector 30 can be comprised within spectrometer 20.

Detector 30 preferably is a mercury-cadmium-telluride (MCT) detector cooled with liquid nitrogen. The spectral range of detector 30 may for example be comprised between 12000 cm⁻¹ and 600 cm⁻¹.

The amplitude of the optical signal O is controlled-around 10000 for a 150 μm diameter and 70 cm long Te₂As₃Se₅ fiber. For all the spectra, 100 scans are acquired. The resolution is for example 4 cm⁻¹. Preferably, the background is acquired before or after the injection of the electrolyte in the cell 12.

Focusing accessory 21, battery cell 12, optical fiber 14 and detector 30 are advantageously placed within a purge chamber 34 for purging any parasite chemical component such as the outside ambient air, and in particular carbon dioxide (CO₂) which is a chemical species of particular interest in the context of observing the decomposition of an electrolyte for example.

Characterization device 10 also comprises a memory (not shown on the Figures) for recording the detected optical signal O. Said memory may be included within the spectrometer or within a computer (not shown) connected to the spectrometer 20.

Characterization device 10 also comprises a processor (not shown on the Figures), for example located within the spectrometer 20 or within a computer, locating signature wavelengths for which the optical signal O intensity is above a predetermined threshold. In other words, peaks of the optical signal O are detected.

Preferably, to simplify the location of the signature wavelengths and their association to predetermined chemical species, after recording the detected optical signal over time, the spectrometer 20 establish a spectrum of said recorded optical signal O.

Then, the processor associates said located signature wavelengths, or spectrum peaks, to at least one predetermined chemical species.

To facilitate the characterization of the chemical species, associating signature peaks to at least one predetermined chemical species involves comparing the located signatures wavelengths to a spectra database associating particular infrared wavelengths to predetermined chemical species.

The spectra database may be established earlier on by inserting the optical fiber 14 in a solution of a pure, predetermined chemical species. Then, using the infrared spectrometer 20, the transmitted optical signal O is detected and recorded, and a wavelength or a set of wavelength for which the recorded optical signal has an intensity above a predetermined threshold are detected. Thus, the signatures wavelengths of said species are obtained and entered within the spectra database. This can be repeated for different expected predetermined chemical species.

Another possibility is to use already-established tables that provide absorption frequencies, usually expressed in wave numbers, for common types of molecular bonds and functional groups.

An illustration of the results obtained through the use of a device according to the invention can be seen on FIG. 3. FIG. 3 illustrates a spectre of the optical signal through optical fiber 14 over time with the intensity of the signal shown in increasingly deep shades of grey, different chemical species can be identified within the electrode. At 0.5 h, the optical signal O has a high intensity at a wavelength corresponding to a wavenumber of 900 cm⁻¹ is acquired. This particular wavelength corresponds to the signature wavelength of NaPF₆. Thus, the presence of NaPF₆ can be attested from 0.5 h after the beginning of the cycling of the battery.

In the same way, at 0.5 h, a series of wavelengths for which the intensity of the optical signal is high is identified. This series of wavelengths are signature wavelengths of dimethyl carbonate (DMC). Thus, the presence of DMC can be attested from 0.5 h after the beginning of the cycling of the battery.

In the same way, at 1 h, a series of wavelengths for which the intensity of the optical signal is high is identified. This series of wavelengths are signature wavelengths of fluoroethylene carbonate (FEC). Thus, the presence of FEC can be attested from 1 h after the beginning of the cycling of the battery.

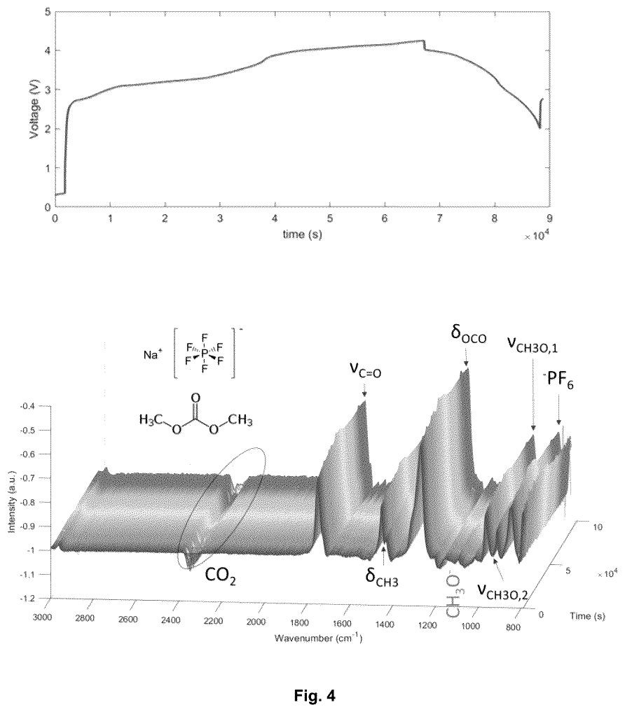

Another example can be seen on FIG. 4, where the spectrum of the optical signal through optical fiber 14 over time has been plotted to identify different chemical species within an electrode, and is compared to a plot of the voltage over time within the battery cell 12 to link the cycling and the spectrum. The identified chemical species are shown above or under the characteristic peaks (wavenumber for which a high intensity is detected and recorded).

Preferably, in order to obtain not only the chemical composition of the battery, but also quantify the thus-characterized chemical species, the processor associates the recorded optical signal intensities of said signature wavelength to a molar quantity of the at least one predetermined chemical species.

To that end, the spectra database can include a calibration curve associating a molar quantity of the at least one predetermined chemical species to the intensity of the optical signal for a particular wavelength.

Such a calibration curve can be obtained by taking into account that the fraction of the light absorbed depends on the concentration and the absorption wavelength. In order to quantify the species that are present within a medium, the Beer-Lambert law for evanescent fiber is then transformed into:

$$A ( {λ}_{p} ) = L {\sum }_{i = 1}^{N} {ε}_{p i} ( {λ}_{p} ) {c}_{i}$$

where A(λₚ) is the absorbance of a solution containing several chemical species, L is the Waveguide length in cm (length of the fiber 14), c is the concentration on mol L⁻¹ and εₚᵢ(λₚ) is the molar absorption of the i species in L mol⁻¹ cm⁻¹.
Thus, for a chemical species characterized by p wavelengths, the Beer-Lambert law for evanescent fiber can be translated into:

$$\{ \begin{matrix}A ( {λ}_{1} ) = L \cdot [ {ε}_{11} ( {λ}_{1} ) {c}_{1} + {ε}_{12} ( {λ}_{1} ) {c}_{2} + … + {ε}_{1 N} ( {λ}_{1} ) {c}_{N} \\ A ( {λ}_{2} ) = L \cdot [ {ε}_{21} ( {λ}_{2} ) {c}_{1} + {ε}_{22} ( {λ}_{2} ) {c}_{2} + … + {ε}_{2 N} ( {λ}_{2} ) {c}_{N} \\ … \\ A ( {λ}_{p} ) = L \cdot [ {ε}_{p 1} ( {λ}_{p} ) {c}_{1} + {ε}_{p 2} ( {λ}_{p} ) {c}_{2} + … + {ε}_{p N} ( {λ}_{p} ) {c}_{N}\end{matrix}$$

To determine the coefficient εₚᵢ(λₚ), different solutions of different concentrations (or different molar quantities) of a predetermined chemical species are prepared, and a linear regression of the absorbance against the concentration of the chemical species can be plotted. Then the association of the intensity of the recorded optical signal of the signature wavelength or set of wavelengths to the concentration of the predetermined chemical species is entered in the spectra database. This allows to calibrate the device and the method according the invention.

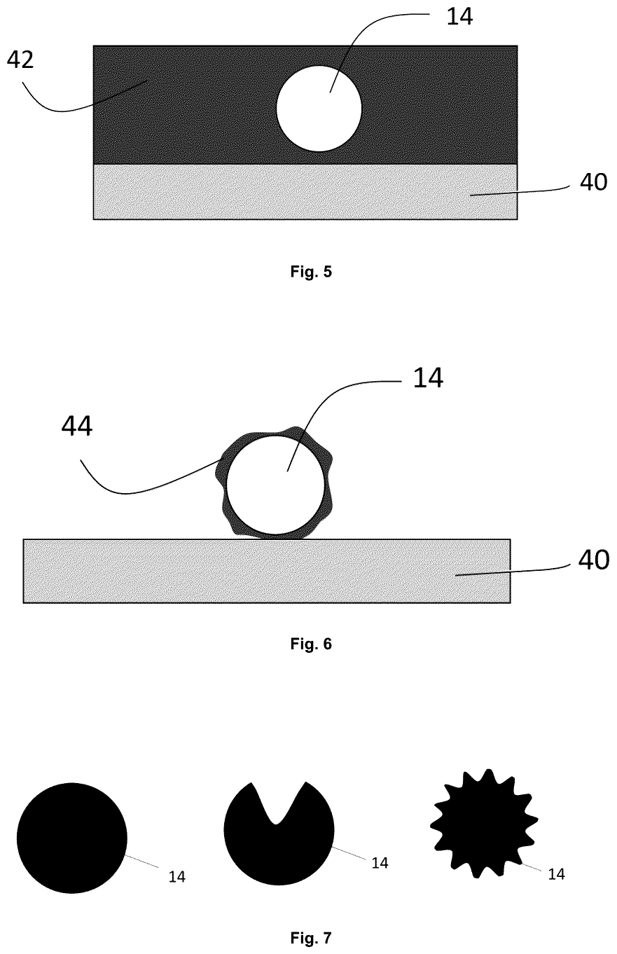

According to a second embodiment of the invention, as shown on FIG. 5, the optical fiber 14 is embedded within the electrode 42 of the cell. The electrode 42 may be placed on top of a current collector 40.

According to a third embodiment of the invention, as shown on FIG. 6, optical fiber 14 is covered with a coating 44 made of a material similar to the one of an electrode of the cell and plunged in the electrolyte. Coating 44 preferably has a thickness comprised between 0 and 10 μm. In that case, optical fiber 14 is preferably placed on top of a current collector 40.

Owing to the coating 44 made of a material similar to the one of the electrode 42, during operation of the battery cell 12, a SEI deposit similar to the one that will form on the electrode 42 will form on the outer surface of the fiber. Hence, the evanescent wave will interact with said SEI deposit and will enable the identification of the species contained within the SEI of the electrode 42. This allows for a very precise detection of the species contained within the SEI as the SEI is directly in contact with the fiber 14, and hence will be in direct contact with the evanescent wave generated by the optical signal.

According to a fourth embodiment of the invention that is not shown, a first optical fiber is placed within the electrolyte, while a second optical fiber is embedded within the electrode of the cell, in order to simultaneously identify, using the method according to the invention, the chemical species that appear both in the electrolyte and the SEI that will form on the electrode.

According to variants, as shown on FIG. 7 the optical fiber 14 may have a cross-section that is either disk-shaped, disk-shaped including a local section that is V-shaped, or star-shaped. This is to increase the outer surface of the fiber 14 and thus increase the interface between the fiber 14 and its environment such as the electrode, the coating, or the electrolyte.

The invention may be used to characterize the chemical species within any kind of batteries. In particular, the invention may characterize typical solvents used in organic electrolytes such as:
Cyclic ethers (tetrahydrofurane, dioxane, 1,3-dioxolane);
Linear ethers (methyl, ethyl and propyl formate, methyl and ethyl acetate, methyl and ethyl propionate) aliphatic ethers;
Linear carbonates (ethylene carbonate, dimethyl carbonate, ethyl methyl carbonate, diethyl carbonate);
Cyclic carbonates (ethylene carbonate, propylene carbonate, 1,2-butylene carbonate, 2,3-butylene carbonate);
Fluorinated (4-fluorotoluene, 1,1,2,2-tetrafluoroethyl 2,2,3,3-tetrafluoropropyl ether, di-fluoro ethylene carbonate, ethyl difluoroacetate); and
aqueous electrolytes, where the solvent is water mixed with an acid (H2SO4), a base (KOH), or a salt (ZnCl2),
any mixtures of the above.

The invention is also suited to characterize typical additives used in organic electrolytes such carbonate (Vinylene carbonate, Fluoroethylene carbonate), tris(trimethylsilyl)phosphite (TMSPi) and succinonitrile (SN), lithiumbis(oxalato)borate (LiBOB), and any mixture thereof.

The invention is also suited to characterize typical salts used in organic electrolytes such as fluorinated salts like Lithium hexafluorophosphate (LiPF6) or Sodium hexafluorophosphate (NaPF6).

The invention therefore allows to record in real-time, in operando, the decomposition of electrolytes, the appearance of chemical species and even quantify them. This opens the way to better understanding the degradation mechanism and instabilities of electrolytes which are linked to the apparition of certain chemical species, and therefore provide guidance to cure such parasitic reactions to enhance battery lifetime. In particular, the formation of the SEI, may be closely monitored using the invention. In addition, owing to this real-time knowledge of the chemical composition of the electrolyte, one may study the influence of different parameters such as temperature, current, voltage, etc. on the battery cycling. Finally, the method according to the invention can be adapted to any kind of battery cell, rendering it particularly convenient.

### LIST OF REFERENCES

10: Characterization device
12: Battery cell
14: Optical fiber
14I: input end of the fiber
14O: Output end of the fiber
16: Electrode of the cell
18: Electrical power source
20: Spectrometer
23: First section of the fiber
24: First connection point of the fiber
25: Second section of the fiber
26: Second connection point of the fiber
27: Third section of the fiber
28: Evanescent wave field
30: Detector
34: Purge chamber
L: Longitudinal direction of the fiber
L1: Length of the second detection section
O: Optical signal

What is claimed is:

1. A method for operando characterization of the chemical composition of a battery cell, comprising the following steps-:
inserting at least one optical fiber made of chalcogenide glass through the battery cell,
generating an optical signal and transmitting it through the optical fiber,
detecting, using an infrared spectrometer, said transmitted optical signal at an output extremity of the optical fiber,
recording the detected optical signal over time,
locating, using fiber evanescent wave spectroscopy, signature wavelengths for which the optical signal intensity is above a predetermined threshold,
associating said located signature wavelengths to at least one predetermined chemical species.

2. The method according to claim 1, wherein it further comprises a step of cycling the battery, wherein the steps of generating an optical signal and transmitting it through the optical fiber, detecting, the transmitted optical signal at an output extremity of the optical fiber, and recording the detected optical signal over time are performed while cycling the battery.

3. The method according to claim 1, wherein it includes, after recording the detected optical signal over time, a step of establishing a spectrum of said recorded optical signal.

4. The method according to claim 1, wherein it further comprises a step of associating the recorded optical signal intensities of said signature wavelength to a molar quantity of the at least one predetermined chemical species.

5. The method according to claim 1, wherein the step of associating signature peaks to at least one predetermined chemical species includes a step of comparing the located signatures wavelengths to a spectra database associating particular infrared wavelengths to predetermined chemical species.

6. The method according to claim 5, wherein the spectra database also includes a calibration curve associating a molar quantity of the at least one predetermined chemical species to the intensity of the optical signal for a particular wavelength.

7. The method according to claim 4, wherein it comprises a prior step of establishing the spectra database.

8. The method according to claim 7 wherein the step of establishing the spectra database comprises the following sub-steps:
inserting an optical fiber made of chalcogenide glass in a solution of a predetermined chemical species,
detecting, using the infrared spectrometer, the transmitted optical signal at an output extremity of the optical fiber,
recording the detected optical signal,
locating a wavelength or a set of wavelength for which the recorded optical signal has an intensity above a predetermined threshold,
entering within the spectra database the association of said wavelength or a set of wavelength to said predetermined chemical species.

9. The method according to claim 8, wherein the molar quantity of the predetermined chemical species within the solution is recorded and the association of the intensity of the recorded optical signal of the wavelength or set of wavelengths and the molar quantity of the predetermined chemical species is entered in the database.

10. The method according to claim 1, wherein the optical fiber is embedded in an electrode of the battery cell.

11. The method according to claim 1, wherein the optical fiber is inserted through the electrolyte of the battery cell.

12. The method according to claim 10, wherein a first optical fiber is embedded in an electrode of the battery cell and a second optical fiber is inserted through the electrolyte of the battery cell.

13. The method according to claim 1, wherein the optical fiber is made from a material comprising essentially Te₂As₃Se₅ glass.

14. The method according to claim 1, wherein the diameter of the optical fiber is comprised between 100 and 400 μm.

15. The method according to claim 1, wherein the chalcogenide glass of the optical fiber is transparent to an electromagnetic radiation the wavenumber of which is comprised between 2 and 12 μm.

16. The method according to claim 1, wherein the optical fiber is covered with a coating made of the same material as an electrode of the battery cell.

17. The method according to claim 1, wherein the optical fiber has a cross-section that is star-shaped or a cross-section that is disk-shaped including a local section that is V-shaped.

18. A characterization device for identifying the chemical species within a battery cell, comprising:
an optical fiber made of chalcogenide glass inserted through the battery cell,
an electrical power source for charging and discharging the battery,
an infrared optical signal generator generating, while cycling the battery, an optical signal through the optical fiber,
a detector detecting the optical signal transmitted through the optical fiber at an output extremity of the optical fiber,
a memory for recording the detected optical signal,
a processor locating signature wavelengths for which the optical signal intensity is above a predetermined threshold within the spectrum and associating said located signature wavelengths to at least one predetermined chemical species.

19. The characterization device according to claim 18, wherein the optical signal generator and detector are comprised within a spectrometer, which is a Fourier transformed infrared spectrometer.

20. The method according to claim 16, wherein the coating has a thickness comprised between 0 and 10 μm.

21. The characterization device according to claim 19, wherein the spectrometer includes a Mercury-cadmium-telluride detector.

22. The device according to claim 21, wherein the Mercury-cadmium-telluride detector has a spectral range comprised between 12000 cm⁻¹ and 600 cm⁻¹.
